(19) United States
(12) Patent Application Publication
(10) Pub. No.: US 2006/0225347 A1
(43) Pub. Date: Oct. 12, 2006

(54) Reformer for fuel cell system

(76) Inventors: Dong-Uk Lee, Suwon-si (KR); Ju-Yong Kim, Suwon-si (KR); Zin Park, Yongin-si (KR); Sang-Jun Kong, Suwon-si (KR); Dong-Myung Suh, Suwon-si (KR)

Correspondence Address: CHRISTIE, PARKER & HALE, LLP, PO BOX 7068, PASADENA, CA, 91109-7068, US

(21) Appl. No.: 11/402,428

(22) Filed: Apr. 11, 2006

(30) Foreign Application Priority Data
Apr. 12, 2005 (KR) 10-2005-0030268
Jun. 24, 2005 (KR) 10-2005-0054828

(51) Int. Cl. B01J 8/00

(52) U.S. Cl. 48/127.9

(57) ABSTRACT

A reformer for a fuel cell system including a plate-type reactor body which has a cavity for a catalyst layer. The reactor body includes a plurality of plates which are separately formed, a bonding portion which is formed between the plates and fixes the plates to one another, an aperture for catalyst insertion, and a finishing unit which seals the aperture.

### CROSS-REFERENCES TO RELATED APPLICATION

This application claims priority to and the benefit of Korean Patent Application Nos. 10-2005-0030268 filed on Apr. 12, 2005, and 10-2005-0054828 filed on Jun. 24, 2005, both applications filed in the Korean Intellectual Property Office, the entire contents of which are incorporated herein by reference.

### BACKGROUND OF THE INVENTION

1. Field of the Invention

The invention relates to a fuel cell system, and more particularly, to a plate-type reformer which generates hydrogen from a fuel.

2. Description of the Related Art

As is well known, a fuel cell is an electricity generating system for generating electric energy by using a fuel (i.e. methanol, ethanol, and natural gas) and oxygen.

A recently developed polymer electrolyte membrane fuel cell (PEMFC) has excellent output characteristics, a low operation temperature, and fast starting and response characteristics in comparison to other fuel cells. In addition, such fuel cells advantageously have a wide range of applications including mobile power sources for vehicles, distributed power sources for home or buildings, and small-sized power sources for electronic apparatuses.

The PEMFC system includes a stack, a reformer, a fuel tank, and the like. The stack constitutes the main body of the fuel cell which generates the electric energy through a reaction between hydrogen and oxygen, and the fuel pump supplies the fuel in the fuel tank to the reformer. The reformer reforms the fuel to generate hydrogen and supplies the hydrogen to the stack.

In the fuel cell system, the reformer generates hydrogen from the fuel through a chemical catalyst reaction using thermal energy. Thus, the reformer may include a plurality of fuel processing units which generate the thermal energy by using the fuel, generating hydrogen through a reforming reaction of the fuel by using the thermal energy, and decreasing a concentration of carbon monoxide contained in the hydrogen.

However, in the conventional reformer, the container-type fuel processing units are distributed apart for each other. For this reason, thermal exchange is not directly performed, resulting in diminished thermal transfer. Furthermore, there is a drawback in that the whole system is not compact.

### SUMMARY OF THE INVENTION

The invention provides a reformer for a fuel cell system which has a plate-type structure, maximizes thermal transfer efficiency, and reduces the overall size of the system.

According to one embodiment of the invention, a reformer for a fuel cell system is provided which includes a plate-type reactor body with an inner space for housing a catalyst layer. The reactor body includes a plurality of plates which are separately formed, a bonding portion which is formed between the plates and fixes the plates to one another, and a finishing unit which caps an aperture used for catalyst insertion and seals the aperture.

In an embodiment of the invention, the finishing unit may be fixed to the plates by welding.

In one embodiment, the plates may include a first metal plate which has a concave portion forming an inner space; and a second metal plate which covers the concave portion and comes in close contact with the first metal plate, wherein the aperture is formed by cutting a portion of a wall of the first metal plate disposed along edges of the concave portion.

In an embodiment, the finishing unit may be formed by a block corresponding to the shape of the aperture and the finishing unit may be inserted into the aperture.

In one embodiment, the plates may include a first metal plate which has a plurality of channels to form the inner space, and a second metal plate which covers the channels and comes in close contact with the first metal plate. The channels are formed by a plurality of ribs disposed on one side of the first metal plate with a specific gap, and the aperture is formed by an opening at one lateral end of each channel.

In another embodiment, the finishing unit may be formed by a bar-shaped block, cover the aperture, and be fixed to the first metal plate and the second metal plate.

In one embodiment, the bonding portion may include a metal thin plate which is disposed between border surfaces of the plates, melts with heat, and bonds the plates.

In an embodiment, the plates may be made of stainless steel or aluminum.

In one embodiment, the metal thin plate may be made of a material having a melting point lower than that of the plates.

In another embodiment, the catalyst layer may be formed with pellet-shaped catalyst in the inner space.

In one embodiment, a reformer may include a plurality of reactor bodies.

### BRIEF DESCRIPTION OF THE DRAWINGS

The above and other features and advantages of the invention will become more apparent by describing exemplary embodiments thereof with reference to the attached drawings in which:

FIG. 1 is a schematic block diagram illustrating a fuel cell system according to an embodiment of the invention;

FIG. 2 is a perspective view illustrating a reformer for a fuel cell system according to an embodiment of the invention;

FIG. 3 is a cross-sectional view the reformer of FIG. 2;

FIG. 4 is a partial exploded perspective view of the reformer of FIG. 2;

FIG. 5 is an exploded perspective view illustrating the structure of the reaction body and a manufacturing method thereof according to an embodiment;

FIG. 6 is a schematic cross-sectional view illustrating the structure of a reformer for a fuel cell system according to another embodiment of the invention;

FIG. 7 is a perspective view illustrating a reformer for a fuel cell system according to another embodiment of the invention;

FIG. 8 is a partial exploded perspective view of the reformer of FIG. 7;

FIG. 9 is a cross-sectional view of the reformer of FIG. 7;

FIG. 10 is a exploded perspective view illustrating the structure of a reactor body of the reformer of FIG. 7 and a manufacturing method thereof; and

FIG. 11 is a schematic cross-sectional view illustrating the structure of a reformer for a fuel cell system according to another embodiment of the invention.

### DETAILED DESCRIPTION

Hereinafter, exemplary embodiments of the invention will be described in detail with reference to the attached drawings such that the invention can be easily put into practice by those skilled in the art. However, the invention is not limited to the exemplary embodiments, but may be embodied in various forms.

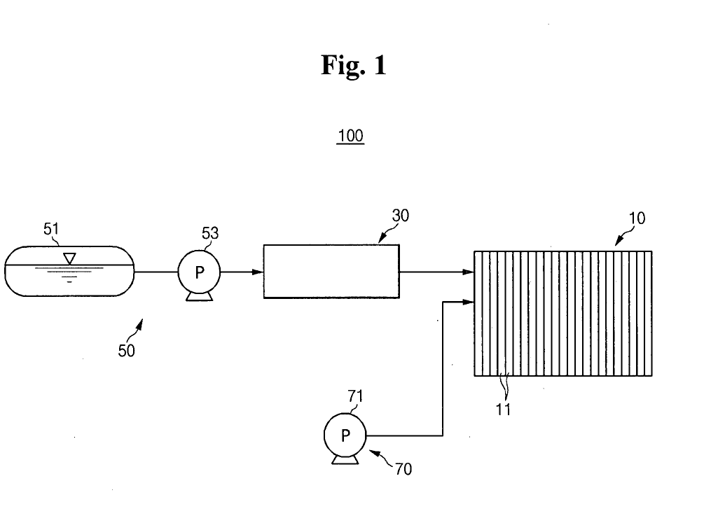

FIG. 1 is a schematic block diagram illustrating a fuel cell system according to an embodiment of the invention.

Referring to the drawing, a fuel cell system 100 is formed as Polymer Electrolyte Membrane Fuel Cell (PEMFC) in which hydrogen is generated by reforming a reactant containing a fuel, thereby generating electric energy.

The fuel used for the fuel cell system 100 includes a liquid or gas fuel containing hydrogen such as methanol, ethanol, or natural gas. In an embodiment, a liquid fuel is used.

In one embodiment, the fuel cell system 100 includes a stack 10 for generating electric energy through the reaction of hydrogen and oxygen, a reformer 30 for generating hydrogen by reforming the reactant containing the fuel and supplying the hydrogen to the stack 10, a fuel supply unit 50 for supplying the fuel to the reformer 30, and an air supply unit 70 for supplying the oxygen to the stack 10.

The stack 10 includes at least one unit of an electricity generator 11 for generating the electric energy. The electricity generator 11 may have a structure in which separators (referred to as “bipolar plates” in the art) are disposed in close contact with both surfaces of a membrane electrode assembly (MEA).

In one embodiment, the stack 10 of the fuel cell system 100 may be constructed by sequentially disposing a plurality of the electricity generators 11.

Since the stack 10 can be constructed as a stack of a general polymer electrolyte membrane fuel cell, a detailed description thereon will be omitted.

In an embodiment, the reformer 30 is composed of a fuel processing unit which chemically changes the aforementioned reactant, and ultimately reforms the fuel provided by the fuel supply unit 50, thereby generating hydrogen.

In an embodiment, the fuel processing unit may include a reforming reaction unit which generates hydrogen through the reforming reaction of the fuel by thermal energy, an oxidation reaction unit which generates the thermal energy through an oxidation reaction of the fuel, and a carbon monoxide refining unit which reduces the concentration of the carbon monoxide contained in the hydrogen.

In one embodiment, the fuel supply unit 50 for supplying the fuel to the reformer 30 may include a fuel tank 51 which stores the fuel and a fuel pump 53 which discharges the fuel and supplies the fuel to the reformer 30.

In an embodiment, the air supply unit 70 may include an air pump 71 which draws air from the atmosphere and supplies the air to the stack 10 with a predetermined pumping pressure. Here, the air supply unit 70 is not limited to the aforementioned air pump 71, but the air supply unit 70 may include a fan with a general structure.

Hereinafter, the reformer 30 according to embodiments of the invention will be described in detail with reference to accompanying drawings.

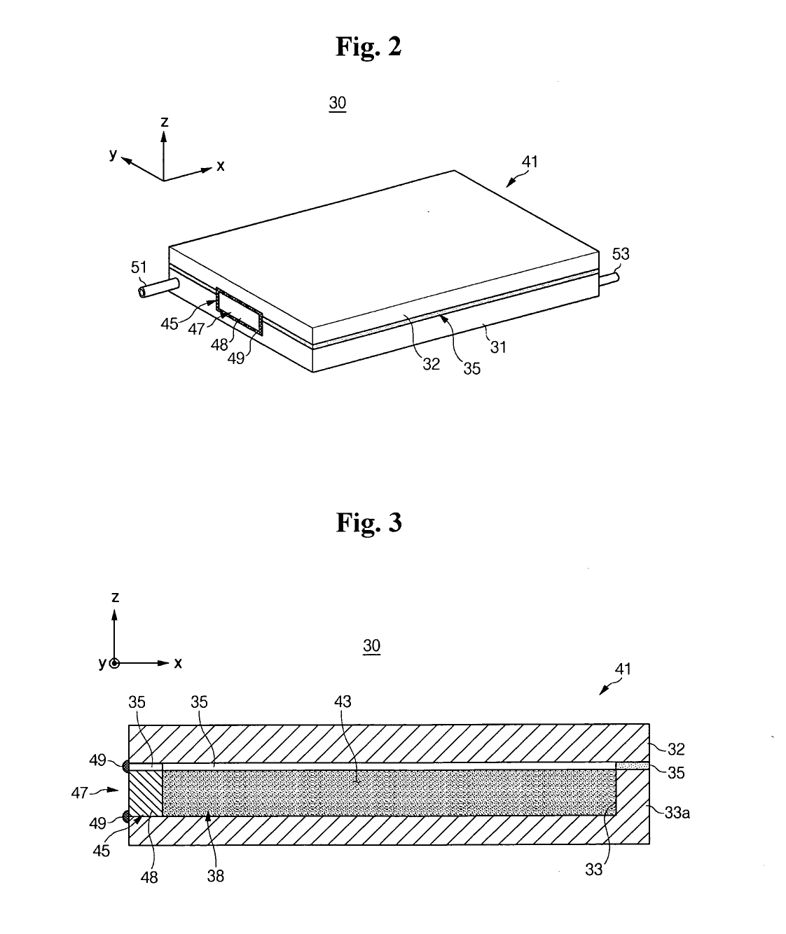

FIG. 2 is a perspective view illustrating a reformer for a fuel cell system according to an embodiment of the invention. FIG. 3 is a cross-sectional view the reformer of FIG. 2.

Referring to the drawings, the reformer 30 includes a reforming reaction unit of the fuel processing unit which generates hydrogen through the reforming reaction of the fuel by using thermal energy.

In an embodiment, the reformer 30 includes a plate-type reactor body 41 in which a catalyst layer 38 is formed to promote the reforming reaction.

In one embodiment, the reactor body 41 is composed of a metal plate which has a substantially rectangular form (see FIG. 2, a rectangle of which the x-axis directional length is longer than the y-axis directional length) and in which a specific cavity 43 (see FIG. 3) is formed. In the cavity 43, a pellet-shaped catalyst is added to form the aforementioned catalyst layer 38.

In another embodiment, the reactor body 41 includes an aperture 45 through which the catalyst is added into the cavity 43 and a finishing unit 47 which closes off the aperture 45 in practice.

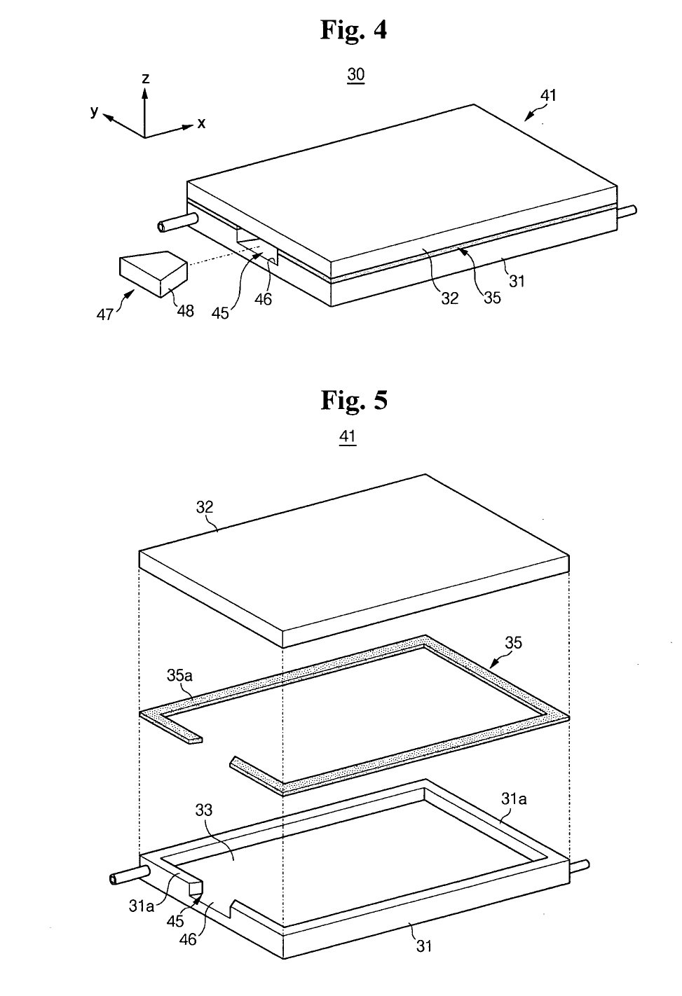

In an embodiment, the aperture 45 is a hole connected to the cavity 43, and is formed at one side of the reactor body 41. In practice, as shown in FIG. 4, the aperture 45 is an open orifice 46 which is formed at one side of the reactor body 41 so that the finishing unit 47 can be inserted to cap off the open orifice 46.

In an embodiment, as shown in the drawings, the aperture 45 may be a single hole formed at a lateral surface of the reactor body 41, but the aperture 45 is not limited thereto. Thus, a plurality of holes may be formed at a lateral surface of the reactor body 41.

The finishing unit 47 may be formed by a finishing block 48 which is connected to an aperture 45 through which catalyst is inserted. The finishing block 48 is inserted through the open end 46 of the aperture 45 to seal the aperture 45.

As shown in FIG. 3, a welding bead 49 is provided on the reactor body 41 to bond the finishing block 48 with the open end 46 of the aperture 45. The welding bead 49 may be formed by laser-welding edges of the finishing block 48 and the open end 46 of the aperture 46.

While sealing a gap between the edges of the finishing block 48 and the open end 46, the welding portion 49 bonds the finishing block 48 to the reactor body 41 so they are integrated with each other.

According to an embodiment, the catalyst layer 38 is formed by adding the pellet-shaped catalyst in the cavity 43 through the aperture 45 of the reactor body 41, and the finishing block 48 is inserted into the aperture 45. Thereafter, the finishing block 48 and the open end 46 of the aperture 45 are laser-welded, thereby forming the reformer 30.

As shown on FIG. 2, the reformer 30 includes an inlet 51 through which the fuel is fed into the cavity 43 and a discharging portion 53 through which hydrogen generated through the reforming reaction of the fuel is discharged.

In an embodiment, the reactor body 41 includes a first metal plate 31 which contains the pellet-shaped catalyst, a second metal plate 32 which is disposed in close contact with the first plate, and a bonding portion 35 which bonds the first plate 31 with the second plate 32 so that they are integrated with each other.

FIG. 5 is an exploded perspective view illustrating the structure of the reaction body and a manufacturing method thereof according to an embodiment.

Referring to the drawing, in the reactor body 41, a first metal plate 31 includes a concave portion 33 corresponding to the aforementioned cavity 43 and an open end 46 corresponding to the aforementioned aperture 45.

In an embodiment, the concave portion 33 is formed inside the first metal plate 31 in a substantial rectangular shape, and the aperture 45 is formed by cutting a portion of a wall 31a of the first metal plate 31, so that an aperture 45 is connected to the concave portion 33.

In an embodiment, the aperture 45 and a finishing block 48 are bonded in a complementary manner at the open end 46.

A second metal plate 32 with a size corresponding to the size of the first metal plate 31 is bonded to the first metal plate 31 by the bonding portion 35 to be described later in detail.

In one embodiment, the first metal plate 31 and the second metal plate 32 are bonded in such a way that the second metal plate 32 comes in contact with the upper surface of the wall 31a of the first metal plate 31. Based on this bonding structure, the aperture 45 can be the hole in which catalyst is inserted.

A bonding portion 35 is disposed and melted at a position where the first metal plate 31 and the second metal plate 32 come in close contact with each other, thereby bonding the first and second metal plates 31 and 32 together.

In an embodiment, the bonding portion 35 may be composed of a thin metal plate 35a having a shape corresponding to the wall 31a of the first metal plate 31 when the thin metal plate 35a is melted/fixed by heat.

In an embodiment the thin metal plate 35a may be formed of a general metallic material with a melting point that is lower than that of the first and second metal plates 31 and 32.

As described above, in one embodiment, a plurality of metal plates are bonded to form a reformer using a brazing/bonding method in which two or more pre-forms are bonded with each other by melting a specific thin metal plate or a metal film.

Hereinafter, a manufacturing method of the reformer will be described.

In one embodiment, the first metal plate 31 which forms the concave portion 33 and the aperture 45, the second metal plate 32 having a size corresponding to the first metal plate 31, and the finishing block 48 having a shape corresponding to the aperture 45 are prepared.

In one embodiment, the thin metal plate 35a is then placed on the wall 31a of the first metal plate 31, and the second metal plate 32 is aligned with the first metal plate 31, so that they are bonded to each other.

Next, through the brazing/bonding method, the first metal plate 31 and the second metal plate 32 are bonded together.

Specifically, with the thin metal plate 35a being disposed therebetween, the first metal plate 31 and the second metal plate 32 are pressed to come in close contact with each other, and in this state, the first metal plate 31 and the second metal plate 32 are heated to a specific temperature.

While in the close contact position, the thin metal plate 35a is melted by the heat, thereby forming the bonding portion 35 at the close contact position between the first metal plate 31 and the second metal plate 32.

Accordingly, the first and second metal plates 31 and 32 are bonded to each other by the bonding portion 35, and thus the containing space 43 formed by the concave portion 33 of the first metal plate 31 and the opening for inserting catalyst formed by the aperture 45 can be included in the reactor body 41.

Thereafter, in an embodiment, a pellet-shaped catalyst is inserted into the cavity 43 through the aperture 45 to form the catalyst layer 38. The finishing block 48 is inserted into the aperture 45, the edges of the finishing block 48 and the open end 46 of the aperture 45 are laser-welded to form the welded bead 49, and the reformer 30 of the embodiment is obtained.

In other words, according to an embodiment, the first and second plates 31 and 32 are bonded using the brazing method to form the reactor body 41 having the cavity 43 and the aperture 45, the catalyst is added to the cavity 43 through the aperture 45, and the aperture 45 is sealed, thereby constituting the reformer 30.

In the manufacturing process of the reformer 30, a catalyst layer is not necessarily formed inside a reactor body through coating. Thus, unlike in the conventional reformer in which the catalyst layer is formed through coating, the invention can prevent the catalyst layer from separating from the reactor body. This is because the catalyst layer formed through the coating is vulnerable to a thermal treatment process.

In an embodiment, when the fuel cell system 100 using the reformer 30 operates, the fuel tank 51 is operated so that a fuel can be supplied to the cavity 43 of the reactor body 41. Then, a reforming reaction occurs due to the catalyst layer 38 while the fuel flows in the cavity 43. Thus, hydrogen is generated by the reforming reaction of the fuel in the reformer 30.

As a result, in the stack 10, according to a reaction between hydrogen supplied from the reformer 30 and oxygen supplied from the air pump 71, electric energy of a predetermined capacity can be produced.

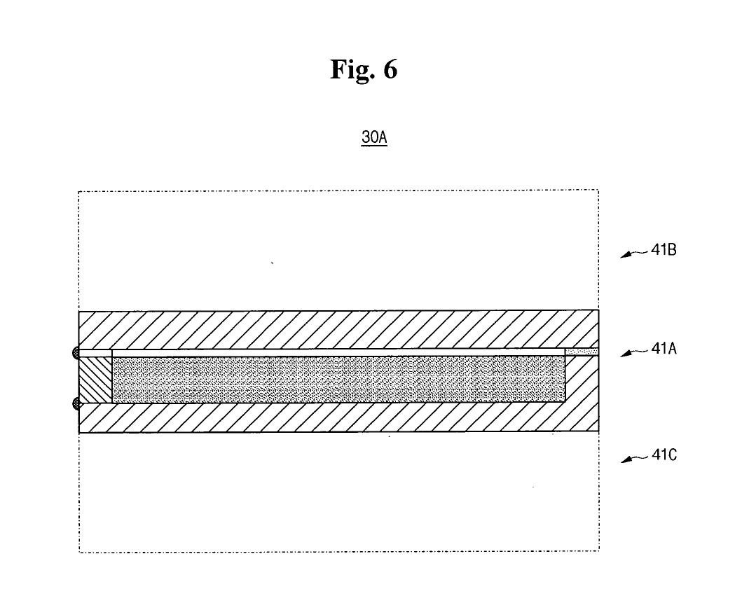

A plurality of reactor bodies may be laminated as shown in FIG. 6 to form a reformer.

FIG. 6 illustrates a reformer 30A in which three reactor bodies 41A, 41B, and 41C are laminated in close contact with one another.

In an embodiment, the reactor bodies 41A, 41B, and 41C have the same structure in the reformer 30A. If the reactor body 41A disposed in the middle portion is a first reactor body, the reactor body 41B disposed in the uppermost portion is a second reactor body, and the reactor body 41C disposed in the lowermost portion is a third reactor body, the second reactor body 41B generates thermal energy in a predetermined temperature range due to an oxidation reaction between a fuel and oxygen. The thermal energy may serve to as an oxidation reactor of a fuel processing unit included in the first reactor body 41A.

In an embodiment, the third reactor body 41B may be included as a carbon monoxide reducing unit (generally referred to as “PROX reactor”) of the fuel processing unit which reduces a concentration of carbon monoxide through an oxidation reaction between carbon monoxide contained in hydrogen generated from the first reactor body 41A and additionally supplied oxygen.

Next, a reformer according to another embodiment of the invention will be described.

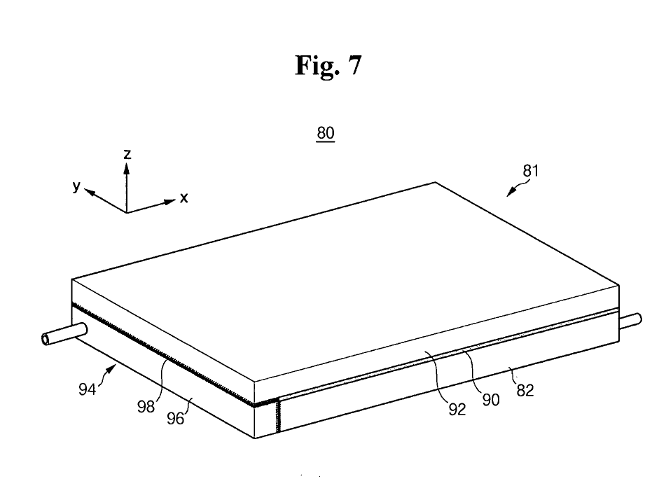

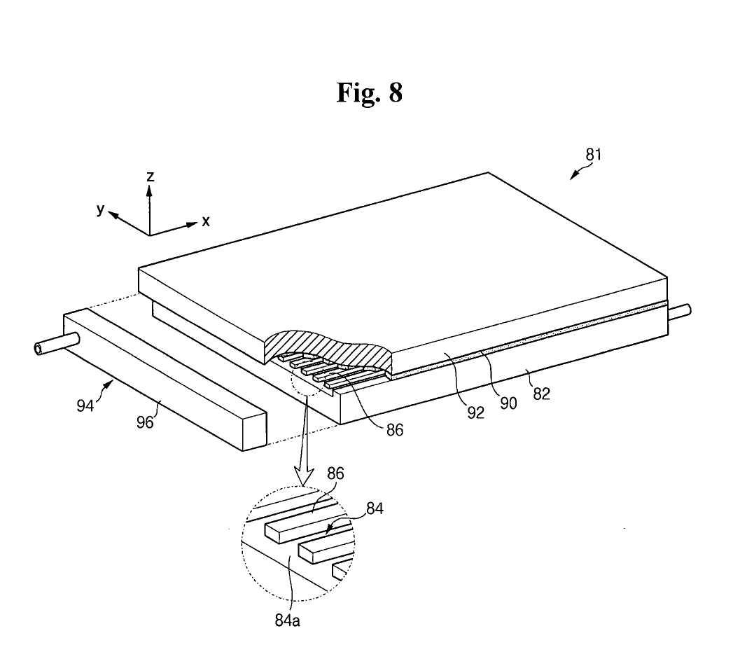

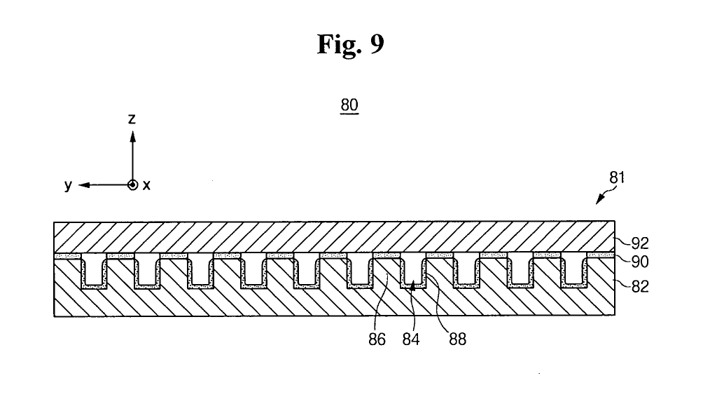

FIG. 7 is a perspective view illustrating a reformer according to another embodiment of the invention. FIG. 8 is a partial exploded perspective view of the reformer of FIG. 7. FIG. 9 is a cross-sectional view of the reformer of FIG. 7.

Referring to FIGS. 7 to 9, a reformer 80 has the same basic structure as the reformers in the previous embodiments.

Hereinafter, descriptions will focus on differences from the reformers in the previous embodiments.

First, the reformer 80 has a plurality of channels 84 as a containing space for a catalyst formed inside a first metal plate 82 of a reactor body 81.

The channels 84 are formed by a plurality of ribs 86 that are disposed on the first metal plate 82 with a specific gap. One end of each of the channels 84 is open, and an aperture 84a is formed so that a catalyst can be inserted therethrough.

In one embodiment, a catalyst layer 88 is formed inside each channel 84, at a lateral surface of each rib 84, on the first metal plate 82.

A second metal plate 92 is disposed over the first metal plate 82, covers the channels 84, and is bonded with the first metal plate 82 through a bonding portion 90. In addition, the second metal plate 92 is larger than the first metal plate 82.

In an embodiment, at one lateral end of the first metal plate 82, a finishing unit 94 is provided which covers the aperture 84a and is fixed to the first metal plate 82. The finishing unit 94 has a bar-shaped block 96 in which the first and second metal plates 82 and 92 have a longer side in the short-axis direction x.

In an embodiment, the block 96 is fixed to the first and second metal plates 82 and 92 through laser-welding or its equivalent, and thus a welding bead 98 is formed between the block 96 and the first and second metal plates 82 and 92.

When the size of the second metal plate 92 is determined, the size of the first metal plate 82 and the size of the block 96 have to be taken into account. In and embodiment, front ends of the ribs 86 facing the block 96 are disposed behind the front end of the first metal plate 82. Therefore, in an embodiment, after the reactor body 81 is formed by combining the first and second metal plates 82 and 92 and the block 96, the channels 84 are connected with one another.

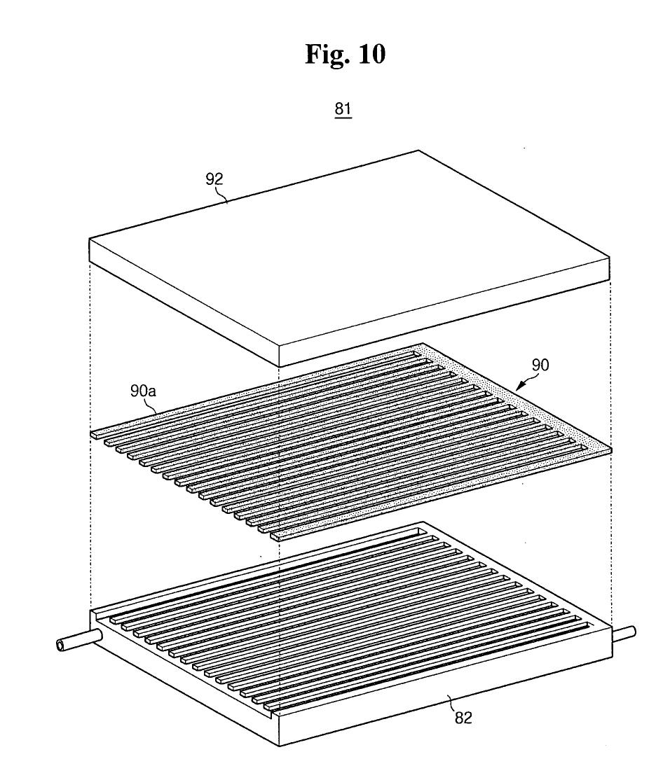

As shown in FIGS. 9 and 10, in an embodiment, the reactor body 81 also can bond the first and second metal plates 82 and 92 through a thin metal plate 90a of the bonding portion 90 disposed at upper surfaces of the ribs 86 on the first metal plate 82 and upper surfaces of edges of the first metal plate 82.

Here, the thin metal plate 90a is also bonded through the thermal treatment process using the brazing method as described above. After the first and second metal plates 82 and 92 are bonded, a catalyst is supplied to the channels 84 through the aperture 84a as shown in FIG. 8, thereby forming the catalyst layer 88.

Other structural features of the embodiment are the same with those of the previous embodiments, and thus a detailed description will be omitted.

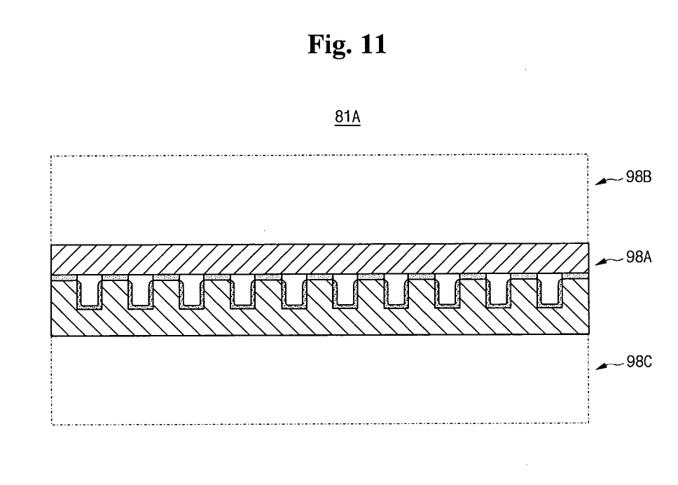

Furthermore, as shown in FIG. 11, in one embodiment, a reformer 81A may include a plurality of reactor bodies 98A, 98B, and 98C.

According to abovementioned embodiments of the invention, a plate-type reformer is constructed in such a way that a pellet-shaped catalyst is added to the inside of a reactor body that has been formed by bonding first and second metal plates using a brazing method. Therefore, the whole system can be compact, and a laminating structure can be used, thereby improving thermal transfer efficiency of the reformer as a whole.

In addition, in one embodiment, since a catalyst layer is formed inside the reactor body after the reactor body has been formed using the brazing method, the catalyst layer of the reactor body will likely not separate from the body due to the heat in the brazing/bonding process of the plates.

While the invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A reformer for a fuel cell system, comprising a plate-type reactor body with a cavity adapted for a catalyst layer,
wherein the reactor body comprises:
a plurality of plates;
a bonding portion between the plates that fixes the plates to one another;
at least one aperture on the plates adapted for catalyst insertion; and
a finishing unit adapted to seal the aperture.

2. The reformer of claim 1, wherein the finishing unit is fixed to the plates by welding.

3. The reformer of claim 1, wherein the plates comprise:
a first metal plate which has a concave portion to form the cavity, wherein the aperture is formed by cutting a portion of a wall of the first metal plate disposed along edges of the concave portion; and
a second metal plate which covers the concave portion and comes in close contact with the first metal plate.

4. The reformer of claim 3, wherein the finishing unit is a block corresponding to the shape of the aperture and is inserted into the aperture to be bonded.

5. The reformer of claim 1, wherein the plates comprise:
a first metal plate which has a plurality of channels to form the cavity, wherein the channels are formed by a plurality of ribs disposed at one side of the first metal plate with a specific gap, and the aperture is formed by opening one lateral end of each channel; and
a second metal plate which covers the channels and comes in close contact with the first metal plate.

6. The reformer of claim 5, wherein the finishing unit is formed by a bar-shaped block, covers the aperture, and is fixed to the first metal plate and the second metal plate.

7. The reformer of claim 1, wherein the bonding portion comprises a thin metal plate which is disposed between surfaces of the plates around the border of the reactor body, is melted by heat, and bonds the plates.

8. The reformer of claim 1, wherein the plates are made of stainless steel or aluminum.

9. The reformer of claim 7, wherein the thin metal plate is made of a material having a melting point lower than that of the plates.

10. The reformer of claim 1, wherein the catalyst layer is a pellet-shaped catalyst added to the cavity.

11. The reformer of claim 1, comprising a plurality of reactor bodies.

12. The reformer of claim 11, wherein each reactor body within the plurality of reactor bodies is in direct contact with at least one other reactor body within the plurality of reactor bodies.
